(19) United States
(12) Patent Application Publication
(10) Pub. No.: US 2011/0313915 A1
(43) Pub. Date: Dec. 22, 2011

(54) COLLECTING AND SHARING REVENUE ASSOCIATED WITH PERSONAL DATA ASSETS

(76) Inventor: Ding-Yuan Tang, Pleasanton, CA (US)

(21) Appl. No.: 13/193,564

(22) Filed: Jul. 28, 2011

Related U.S. Application Data
(63) Continuation-in-part of application No. 12/539,562, filed on Aug. 11, 2009.
(60) Provisional application No. 61/087,964, filed on Aug. 11, 2008.

(51) Int. Cl. G06Q 20/00

(52) U.S. Cl. 705/39

(57) ABSTRACT

A personal data asset portal or service is provided to collect personal data assets associated with a user. Personal data assets, such as data associated with or generated by interaction a user, may be of interest to third parties such as marketers. Personal data assets may be generated through normal use of personal data generation devices such as mobile phones, navigation systems, personal computers, payment transponders, etc. and through interacting with buildings, vehicles and other elements of a user's environment. Personal data assets may include physical locations visited by the user, virtual locations (Web sites) visited by the user, telephone numbers dialed by the user, payment transactions for the user, etc. Access to personal data assets is selectively provided by the user to the third parties for a fee. Personal data assets may be bundled or aggregated by one or more services; users may be bundled into a group. Advantageously, at least a part of the fee or some benefit or advantage is shared with the user, group or user and group.

### CROSS-REFERENCE TO RELATED APPLICATIONS

For purposes of the USPTO extra-statutory requirements, the present application constitutes a continuation-in-part of U.S. patent application Ser. No. 12/539,562, titled COLLECTING PERSONAL DATA FROM A USER AND SHARING REVENUE GENERATED FROM THE SALE OF THE PERSONAL DATA, naming Ding-Yuan Tang as inventor, filed 11 Aug. 2009, or is an application of which a currently co-pending application is entitled to the benefit of the filing date.

For purposes of the USPTO extra-statutory requirements, the present application also constitutes a continuation-in-part of U.S. patent application Ser. No. 61/087,964, titled ORGANISING AND MONETIZING PERSONAL DATA, naming Ding-Yuan Tang as inventor, filed 11 Aug. 2008, which is an application of which a currently co-pending application is entitled to the benefit of its filing date.

The United States Patent Office (USPTO) has published a notice effectively stating that the USPTO's computer programs require that patent applicants reference both a serial number and indicate whether an application is a continuation or continuation-in-part. Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND OF THE INVENTION

1. Field of the Invention

Implementations of the present invention relate generally to capturing data, metadata, and information anytime it is available and when it is correlated, connected to or associated with an individual or one or more items with which she interacts. Specifically, the present invention relates to a system, device and method for using and treating personally connectable information (PCI) as an asset to a person—a personal data asset.

2. Related Art

Each day, substantial amounts of digital and analog information is generated or is available as an individual interacts with various devices, vehicles, buildings and other things in his or her environment. Some of this data is connectable to or can be associated with a particular individual. One term for this type of information is personal data. Similarly, while interacting with certain free and paid services, such as over the Internet, information is captured. Some of this information is of interest to third parties such as marketers. There are may sources of personal information or personal data including through normal use of mobile phones, Global Positioning Systems (GPS's), navigation systems, payment transponders, and Internet Service Providers (ISP's). Typically, such personal data is purchased from companies that specialize in the collection of this type of data. However, some individuals are of the opinion that this type of data should belong to the user or at least be shared openly with the user. A company, government or other entity should not be completely free to collect and store personal data without sharing the data with the user or at least advising the user when information associated with the user is collected.

Some people argue that each individual user agrees, either explicitly or implicitly (legally, morally or logically) to exchange data associated with the individual in exchange for a free service. While this is true in many circumstances, it is in no way universal. Currently, there are few individuals within private and public companies, and within governments and governmental agencies, who advocate for and represent individuals and champion a person's right to personal data—if such a right exists. Further, even if there were such a right, there are no mechanisms in place to share or partner with individuals to gather, share and monetize the personal data for the benefit of the individuals.

These and other shortcomings of the current art are overcome by use of the present invention.

### SUMMARY

One aspect of the present invention provides a system, device and method for a personal data service to collect personal data assets associated with a user. The personal data service may include a portal through which a user may interact with the service. Personal data assets may be of interest to third parties such as marketers.

In another aspect, personal data assets are generated through normal use of personal data generation devices such as mobile phones, navigation systems, personal computers, environmental computers, vehicle computers, payment transponders, etc. and through interaction with buildings and other elements on, in and around a user. Personal data assets may be data that identifies physical locations visited by a user, virtual locations (e.g., websites, portals, virtual machines) visited by a user, telephone numbers dialed by the user, payment transactions for the user, items purchased by a user, discounts used by a user, etc.

In yet another aspect of the invention, access to collected personal data assets is selectively provided to the third parties for a fee. Advantageously, at least a part of the fee or other benefit is shared with the user or a group with which the user is affiliated.

In a further aspect of the invention, personal data assets may be aggregated or bundled across a group, company, entity, residence, doctor's office, government agency, neighborhood or other group or collection. Personally identifying information may or may not be included in the aggregated form. The personal data assets may be accessed by or provided to third parties for a fee, the fee being split in one of several ways with the participants in the group or may be collected by an entity associated with the group.

This Summary introduces a selection of concepts and aspects of the invention in a simplified form that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

The novel features believed characteristic of the subject matter are set forth in the appended claims. Throughout, like numerals refer to like parts with the first digit of each numeral generally referring to the figure which first illustrates the particular part. The subject matter and a preferred mode of use are best understood by reference to the following Detailed Description of illustrative implementations when read in conjunction with the accompanying drawings.

FIG. 1 shows a diagram illustrating a data service collecting and monetizing personal data assets in accordance with one exemplary implementation of the invention.

FIG. 2 shows a diagram illustrating a data service that collects and monetizes personal data assets that have been aggregated by a group service whereby revenue is shared with a group or entity in accordance with another exemplary implementation of the invention.

FIG. 3 shows a diagram illustrating a data service that collects and monetizes personal data assets that have been aggregated by a group service and by a private service whereby revenue is shared with a group and users, respectively, in accordance with yet another exemplary implementation of the invention.

FIG. 4 shows a block diagram illustrating revenue streams for a typical user or individual participating in a society in accordance with the teachings of the invention described herein.

FIG. 5 shows a diagram illustrating steps of a method for sharing revenue with a group or users associated with a group in exchange for providing access to personal data assets in accordance with the teachings of the invention described herein.

FIG. 6 shows exemplary hardware or device that may be used to implement the teachings of the invention described herein.

### DETAILED DESCRIPTION

Described is a device, system and method for a personal data portal to collect and monetize personal data assets associated with a user as explained more fully herein. Personal data assets may be of interest to third parties such as marketers. Personal data assets are generated through normal use of data generation devices such as mobile phones, navigation systems, personal computers, payment transponders, etc. and through interacting with buildings, vehicles and other elements of a user's environment. Personal data assets may include physical locations visited by the user, virtual locations (websites) visited by the user, telephone numbers dialed by the user, payment transactions for the user, etc. Personal data assets may also include a user's revenue history such as information associated with previous purchases made by the user. Selective access to collected personal data assets is provided to one or more third parties for a fee. Prior to being exposed for further use, personal data assets of members of a group or entity may be aggregated or bundled. The individuals and/or group may advantageously share at least a part of the fee or otherwise receive some benefit or advantage. Alternatively, individuals and/or group may give away their personal data assets for free if desired. Personal data assets maybe made available for a temporary time, or over a small or large portion of time, or intermittently according to a scheme determined by the individual, group or third party.

Some people believe in and assert a right to privacy. Some of these people also believe that data generated by them, through their purchased or leased devices, should be protected under their right to privacy. They should own their digital footprint or digital life and not the companies and other entities that have access to their data. Further, it can be argued that copyright law provides people protection over their digital footprint because their individual choices and interactions with their devices and environment are their creative expressions and are recorded in a tangible medium. Individuals should decide how much of their personally generated data is known or captured by businesses and other entities and not the other way around. At the very least, individuals should be able to capture, protect and use their own copy of their personally generated data or “personal data assets” as they see fit. Individuals should have the power to market and sell access to these assets.

Historically, people have given away or shared their data in exchange for consuming, receiving or using a free electronic service (e.g., email, social networking, file hosting, blogging). People have also voluntarily enriched retailers and other entities with huge volumes of data. People have automatically left a trail of purchase habits, reviews and other feedback and data as part of their interactions with Web sites and other services of retailers and similarly situated entities. Such data has hitherto been exploited solely by the entities that have the power to record the information. The individuals creating the data have been left powerless until now.

Through the invention described herein, people that have traditionally been just consumers and unremunerated or unrewarded contributors may share in the monetization of the data that they generate or create.

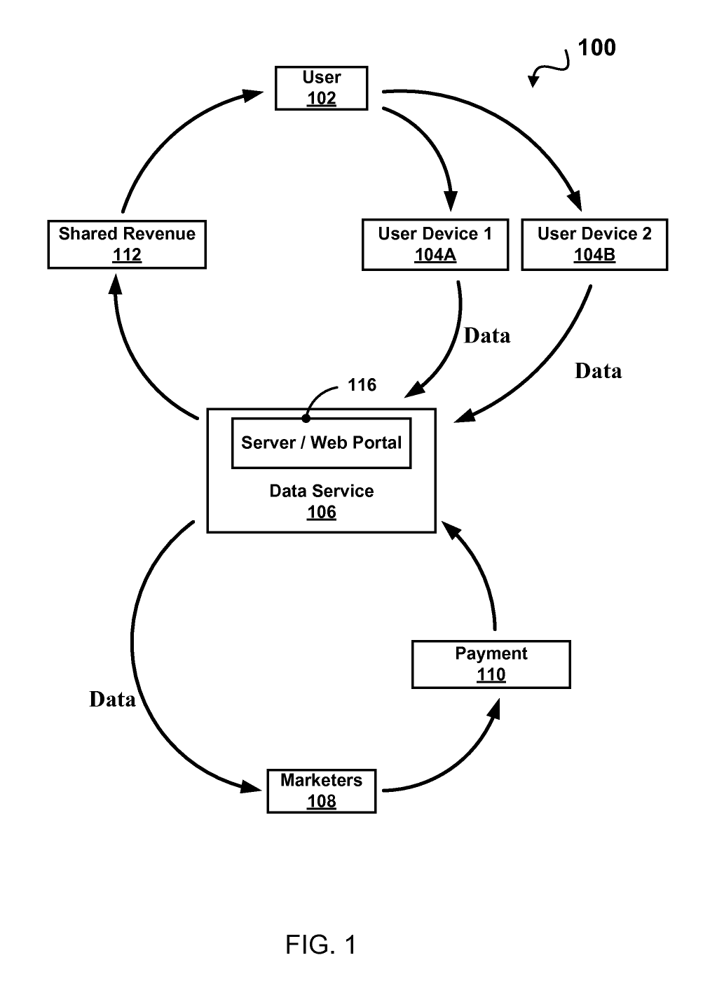

FIG. 1 shows a diagram illustrating a data service collecting and monetizing personal data assets in accordance with one exemplary implementation of the invention. With reference to FIG. 1, one or more users 102 generate data through devices. For example, a user 102 causes a personal data generation device such as a first user device 104A and a second user device 104B to generate, transmit or record data. A data service 106 collects and facilitates monetizing of such data or personal data assets. A server, web portal or personal data asset portal 116 may be associated or in electronic communication with the data service 106. Through the personal data asset portal 116, a user 102 may interface with the data service 106 to monitor which types and amounts of data from the first user device 104A and second user device 104B are recorded and made available to marketers 108. In exchange for access to user data, marketers 108 are required to make payment 110 to an entity (not shown) that operates or is associated with the data service 106. In turn, such entity passes along a portion or all of the payment 110 to the user 102 as shared revenue 112. For a plurality of users 102, the revenue is shared with each of the users participating in the data service 106.

The sharing of revenue may be made in proportion to the number of devices registered by each user, the amount of data generated by each user or some other metric such in proportion to a number of users aggregated in a particular group. For example, if a marketer 108 makes a payment to gain access to data associated with a particular group of users 102, each user 102 may be remunerated more for belonging to a larger group than to a smaller group. The users 102 may self-group or the users 102 may be bundled together based on one or more criteria. The marketer 108 may have the freedom to select or group the users 102, or the operator of the data service 106 may offer to marketers 108 data that is bundled according to one or more criteria. For example, the operator may form a group of data from male users between the ages of 18 and 24. Other groupings are possible. In another example, the grouping may be according to the type of device used by users, or may be by amount of data generated by the users in a group, or may be according to a use metric by an application operating on one or more of a user's registered devices 104A, 104B. Although not shown, those familiar with the art will appreciate that each device or service in the system may be required to operate one or more of a software, application program interface (API), firmware or service in order to participate in the system.

In an exemplary scenario and with reference to FIG. 1, a user 102 registers a user profile (not shown) with the data service 106. The user profile may include such information as name, age, profession, physical address, etc. Alternatively, the user profile only includes information identifying the first user device 104A, second user device 104B, or both the first user device 104A and second user device 104B, etc. As part of the registration process, the user 102 may select appropriate privacy and marketing options to control to whom and under what terms and conditions the user's personal data may be sold or otherwise used.

As part of the registration process, a user 102 registers at least one associated personal data generation device 104A, 104B. The data service 106 uses information and/or permission obtained through the registration process to gain access to at least some of data generated by or recorded by the personal data generation device 104A, 104B. For example, said devices 104A, 104B may be a mobile phone, smart phone, watch, car, laptop computer, desktop computer, in-car GPS system, or an application such as a web browser, word processor, smart phone application (“app”).

After each device 104A, 104B has been registered, one or more components of the system 100 (such as the data service 106) collect data generated by each registered device 104A, 104B when the respective device or devices are used. Each registered device 104A, 104B transmits data in the system 100 via one or more communication channels such as one available to the data service 106. In accordance with embodiments of the invention, the communications channels may include a wired or a wireless network connection.

From the data collected, a user 102 can visit the portal 116 to get a better understanding of his or her habits such as travelling patterns, shopping habits, communication habits, daily activities, etc. From this understanding, a user 102 may make appropriate changes to habits based on say an efficiency analysis of the habits. Further, a user 102 may have an option to upload, correct or enter purchase information or other types of information into the data service 106 or portal 116. Such supplemental data may provide the needed context for gathered data or use data and may thus make recorded data much more valuable to third parties and other users of the system.

In one embodiment, the portal 116 may be configured to import or access other data for cross-referencing purposes—data that is stored by the data service 106 or data that is external to the data service 106. The importing or accessing of other data may be done automatically once configured or may prompt a respective user each time a user interacts with the system or device within the system. This other data may include electronic bank/credit card statements, mobile phone calling records, etc. held or made available by other entities. By cross-referencing with a second, third or fourth data source, a user can get a delta on his pattern and further optimize his or her efficiency analysis.

As part of an exemplary implementation, the data service 106 also allows a user to enter other data annotations, comments, feedback, reviews, ratings or attributes, for example, “I came to this restaurant for my birthday”, “I came to this store to buy Christmas gifts”, “I am the member of this golf club”, “I like the quality of service”, “This is my favorite restaurant—they are a bit expensive”, etc. Such information is shared to provide additional suggestions for other users whom also frequent a same travel route or seek recommendations in a certain geographic area or on a certain topic.

Data collected from users 102 represents valuable information for marketers. In one implementation, collected data may be searchable based on sorted parameters and purchased directly from the system 100. User profile data entered by each user 102 makes collected data even more valuable than just raw data without classification parameters.

In one implementation, when data has been purchased from the system 100, each of the users 102, who are ultimately responsible for generating monetizable data, will get a share of the profit generated from any data purchase.

In one implementation, users 102 that have spent more time in refining their data by cross referencing it with additional data sources and providing ratings and comments will also get paid more for the time, effort and care invested into the system when this type of data is found more valuable. For some marketers, this type of data is more refined and holds higher value than just pure time, location, use and other raw data generated by participating users.

Advantageously, beside a financial gain to users 102, this approach can ensure privacy of personal data. Each user 102 ultimately has more control over how personal data or personal information is made available, used and marketed.

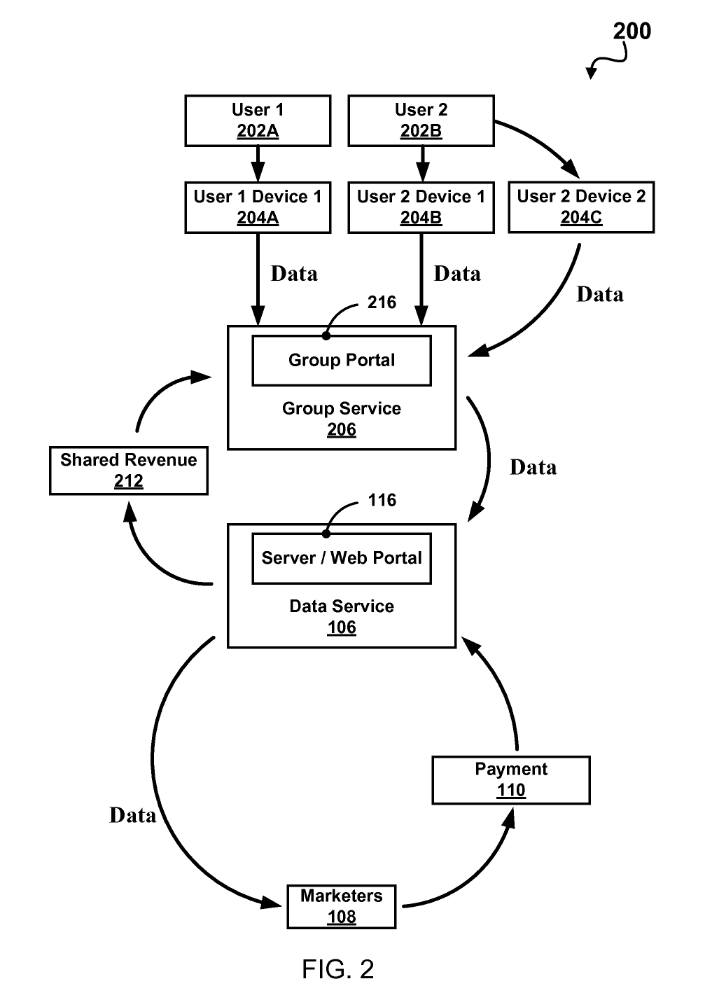

FIG. 2 shows a diagram illustrating a data service that collects and monetizes personal data assets from a plurality of users that belong to a group, wherein the personal data assets may be aggregated by a group service. With reference to FIG. 2, a first user 202A and a second user 202B belong to a group (not shown). The first user 202A uses a first device 204A (labeled “User 1 Device 1”). The second user 202B uses a second device 204B and a third device 204C (labeled “User 2 Device 1” and “User 2 Device 2,” respectively).

In an exemplary scenario of the group service 206, the first user 202A and the second user 202B register with the group service 206 and have access to a group portal 216 through which they can manage their respective profiles. As part of registration, users 202A, 202B associate or register their respective devices 204A, 204B, 204C with the group service 206. Alternatively, users 202A, 202B register accounts with a third party service (not shown) with the group service 206. Through use, data from the devices 204A, 204B, 204C (or third party service) is received by, collected and stored by the group service 206. In turn, either intermittently, continuously or some combination thereof, data is or may be transferred or made available to a data service 106 that is accessible by marketers 108. In exchange for access to group user data, marketers make payment 110 to an entity associated with the data service 106 or to an entity associated with the group service 206. If payment 110 is made to the data service, in turn, shared revenue 212 is provided to an entity associated with the group or with the group itself. The group or entity representing the group may or may not split or deliver shared revenue with users that belong to the group. Alternatively, users may be given an option to participate or share their data without being compensated in any way. User data may be bundled by the group service 206, the data service 106 or by marketers 108 after the marketers 108 purchase access to the user data.

There are many exemplary applications of a group service 206 as described herein. For example, a plurality of users that have electronic readers may join a portal or group service. The users each register their devices with the group service. A software application on each of the devices detects user data, accesses user data, and transmits user data to the group service. The user data is aggregated, made available to a data service such as the one shown in FIG. 2, and the user data is sold or made available to marketers for a fee. Continuing this example, a publisher could enter into a contract with the group service 206 (or the data service 106) and could purchase access to electronic reading habits of the users belonging to the group and participating with the group service 206. In exchange, the group (and perhaps each of the users) would be remunerated for sharing the data with the publisher. In practice, while installation or operation of a software application on each user's device may violate terms of service or a contract associated with a respective device, users 202A, 202B could financially benefit from participating with the group service 206. Currently, without the use of the invention described herein, users do not have a mechanism whereby to participate in revenue generated from the data from electronic readers.

In another example, employees of a for-profit company are required by the company to sign up with a company-operated group service. The employees share their airline ticket purchase information (such as through use of their airline frequent flyer accounts). The company group service 206 aggregates their travel data (history) and makes the travel data available (perhaps through removing personally identifying information) to marketers. In exchange, the company is remunerated thereby lowering the travel costs to the company. The company travel information may be shared and aggregated by a data service 106 with travel data from individuals and yet other travel data aggregated from other companies. Marketers would be able to identify groups (e.g., companies) that have particular needs. An airline company could identify and directly market to companies that frequently user its airline services. In this way, groups are directly benefited by participation by users in the system. By having companies aggregate and expose their data to marketers and other third parties, a new mechanism of commerce is possible. Retailers and other purveyors of goods and services can reach out to potential customers—groups as well as individuals.

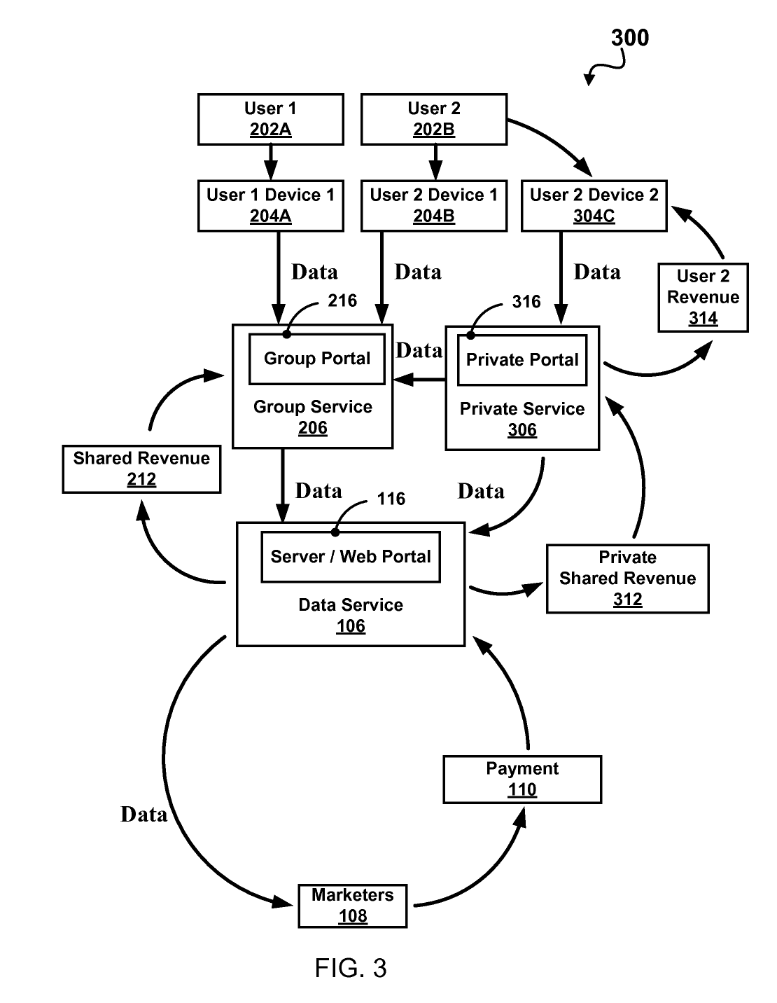

FIG. 3 shows a diagram illustrating a data service that collects and monetizes personal data assets that have been aggregated by a group service and by a private service whereby revenue is shared with users corresponding to data that is aggregated and monetized. With reference to FIG. 3, a first user 202A and a second user 202B belong to a group (not shown). The first user 202A uses a first device 204A (labeled “User 1 Device 1”) that can be associated with or belongs to the group. For example, the first device 204A is a company-owned cellular telephone that is provided to the first user 202A. The second user 202B uses a second device 204B (labeled “User 2 Device 1”) that can be associated with or belongs to the group. In addition, the second user 202B has access to or owns a third device 304C (labeled “User 2 Device 2”) that is not currently associated with the group and, for example, belongs privately to the second user 202B.

For example, the third device 304C is a personally owned cellular smart telephone that the second user 202B often uses in addition to a company-provided cellular telephone. As another example, the third device 304C is an in-dashboard GPS enabled vehicle computer in a car belonging to the second user 202B. As yet another example, the third device 304C is a tablet computer that is personally owned by the second user 202B and is carried to and from her place of work every day along with the second device 204B.

In an exemplary scenario of the group service 206 and the private service 306 as shown in FIG. 3, the first user 202A and the second user 202B register with the group service 206 and have access to a group portal 216 through which they can manage their respective profiles. As part of registration, users 202A, 202B associate or register their respective devices 204A and 204B with the group service 206. At this point, the second user 202B desires to monetize his personal data assets associated with his second device (the third device 304C shown in FIG. 3). Data from the first device 204A and the second device 204B are received by, collected and stored by the group service 206. Further, data from the third device 304C is received by, collected and stored by the private service 306. In turn, either intermittently, continuously or some combination thereof, data is or may be transferred or made available from both the group service 206 and the private service 306 to the data service 106 that is accessible by marketers 108.

In exchange for access to group user data, marketers make payment 110 to an entity associated with the data service 106, to an entity associated with the group service 206, and/or to an entity associated with the private service 306. If payment 110 is made to the data service 106, in turn, shared revenue 212 is provided to an entity associated with the group or with the group itself. The group or entity representing the group may or may not split or deliver shared revenue with the first user 202A and the second user 202B for the data passing through the group service 206. However, irrespective of shared revenue 212 sent to the group, based on an agreement with the private service 306, the second user 202B receives user shared revenue 314 based upon data shared from the third device 304C.

In a preferred implementation, data from the third device 304C (some of the data originating from the second user 202B) is aggregated with data from the first device 204A and second device 204B. Data from the third device 304C (via the private service 306) may be transferred to or aggregated by the group service 206 in equipment operated by the group service 206, or this data from the third device 304C (via the private service 306) may be transferred to or aggregated by the data service 106. Any number of devices in possession or control of the second user 202B may be likewise registered with the private service. The more devices registered, and the more data that is bundled with the group from the second user 202B, the more shared user revenue 314 is sent to the second user 202B. Thus, there is an incentive to the second user 202B to aggregate his data with that of the group and the data of the group service 206. Similarly, the group and group members (the first user 202A and the second user 202B) receive more shared revenue 212 as more devices from the group members are registered with the group service 206. Thus, users may be incentivized by seeking additional revenue for the group or additional revenue for themselves. Optionally, the second user 202B may opt to share data from the third device 304C without receiving any remuneration, benefit or other reward.

The following is an example of the scenario described above in relation to FIG. 3. In this example, employees of a for-profit company are issued company leased cellular smartphones (such as the first device 204A and the second device 204B). The second user 202B desires to generate revenue from his tablet computer (the third device 304C). The second user 202B registers his tablet computer with a private service 306. In turn, the third device data is aggregated with data from the first device 204A and the second device 204B. Once marketers 108 purchase access to aggregated data, both the group (i.e., for-profit company) and the second user 202B are remunerated for having their devices and data participating in the system 300.

In a preferred implementation, either a group service 206 or a private service 306 is able to detect when a third device 304C is available for aggregation. For example, suppose the third device 304C is a cellular device or a GPS-enabled device. The third device 304C is carried on most days (such as during normal business hours) to the same location where the first device 204A and the second device 204B are located or operate. Upon detecting that the third device 304C is possibly associated, groupable or bundable with the first device 204A and the second device 204B, an invitation is sent to an application or an account associated with the second user 202B, associated with the third device 304C or is sent directly to the third device 304C. In this way, a second user 202B is advised of the potential of being remunerated by bundling data from the device 304C with a group and aggregated data from the first device 204A and the second device 204B.

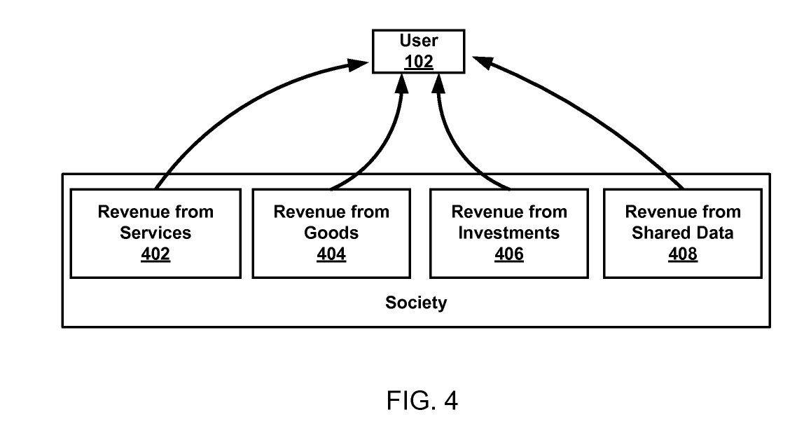

FIG. 4 shows a block diagram illustrating revenue streams for a typical user or individual participating in a society in accordance with the teachings of the invention described herein. Previously, with reference to FIG. 4, a user 102 or societal participant had a number of ways in which to generate personal income. These ways included receiving revenue from services that the user rendered 402, from the sale of goods 404 made by or enhanced by the user, and from investments 406. When a user 102 participates in the system described herein (such as a data service), by making his personal data assets available to the system, the user 102 has a further mode or way in which to generate revenue.

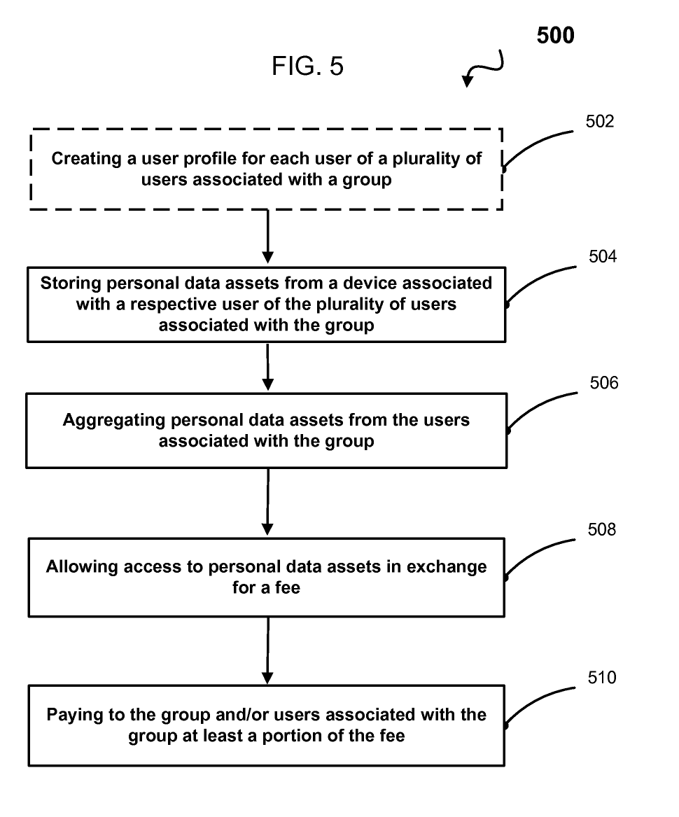

FIG. 5 shows a diagram illustrating steps of a method for sharing revenue with a group or users associated with a group in exchange for providing access to personal data assets in accordance with the teachings of the invention described herein. With reference to FIG. 5, the method comprises (optionally) a step 502 of creating a user profile for each user of a plurality of users associated with a group. The method further comprises a step 504 of storing personal data assets or personal data assets from a device that is associated with a respective user of a plurality of users that are associated with a group. Next, the method comprises a step 506 of aggregating personal data assets or personal data assets from the users that are associated with the group. After aggregation of personal data assets, the method comprises a step 508 of allowing access, such as to a marketer, to the aggregated personal data assets in exchange for a fee. Next, the method comprises a step 510 of paying to the group or users associated with the group at least a portion of the fee paid by the marketer. The method comprises other steps as further described herein.

### Exemplary Hardware

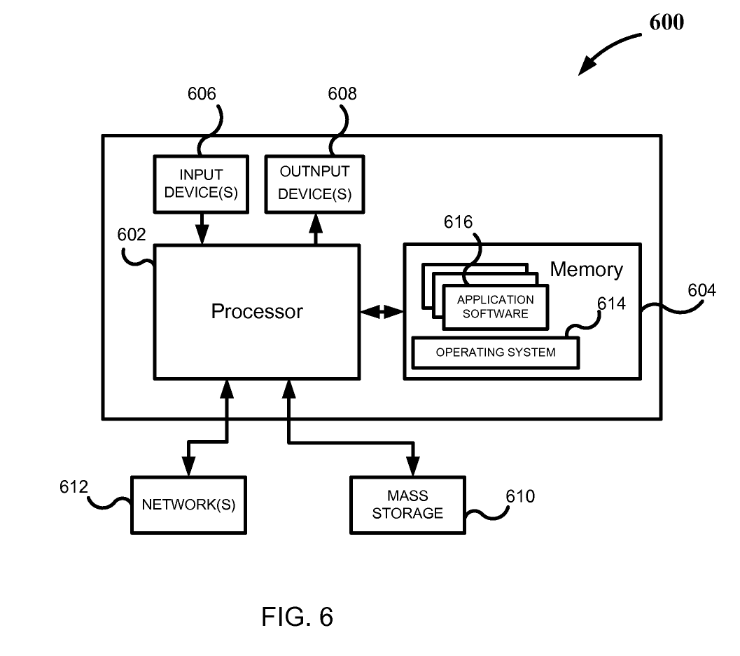

FIG. 6 shows an exemplary hardware or device 600 that may be used to implement implementations of the system and methods described herein. The system 600 may include at least one processor 602 coupled to a memory 604. The processor 602 may represent one or more processors (e.g., microprocessors), and the memory 604 may represent random access memory (RAM) devices comprising a main storage of the system 600, as well as any supplemental levels of memory e.g., cache memories, non-volatile or back-up memories (e.g. programmable or flash memories), read-only memories, etc. In addition, the memory 604 may be considered to include memory storage physically located elsewhere in the system 600, e.g. any cache memory in the processor 602 as well as any storage capacity used as a virtual memory, e.g., as stored on a mass storage device 610.

The system 600 also typically receives a number of inputs and outputs for communicating information externally. For interface with a user or operator, the system 600 may include one or more user input devices 606 (e.g., a keyboard, a mouse, imaging device, etc.) and one or more output devices 608 (e.g., a Liquid Crystal Display (LCD) panel, a sound playback device (speaker, etc)).

For additional storage, the system 600 may also include one or more mass storage devices 610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 620 may include an interface with one or more networks 612 (e.g., a local area network (LAN), a wide area network (WAN), a wireless network, and/or the Internet among others) to permit the communication of information with other computers coupled to the networks. It should be appreciated that the system 600 typically includes suitable analog and/or digital interfaces between the processor 602 and each of the components 604, 606, 608, and 612 as is well known in the art.

The system 600 operates under the control of an operating system 614, and executes various computer software applications, components, programs, objects, modules, etc. to implement the techniques described above. Moreover, various applications, components, programs, objects, etc., collectively indicated by reference 616 in FIG. 6, may also execute on one or more processors in another computer coupled to the system 600 via a network 612, e.g. in a distributed computing environment, whereby the processing required to implement the functions of a computer program may be allocated to multiple computers over a network. The application software 616 may include a set of instructions which, when executed by the processor 602, causes the system 600 to implement the method of the invention.

The foregoing discussion has been presented for purposes of illustration and description. Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Various features from one implementation can be combined with other features from other implementations. The description is not intended to limit the invention to the form or forms disclosed herein. Consequently, variation and modification commensurate with the above teachings, within the skill and knowledge of the relevant art, are within the scope of the present invention. The implementations described herein and above are further intended to explain the best mode presently known of practicing the invention and to enable others skilled in the art to use the invention as such, or in other implementations, and with the various modifications required by their particular application or uses of the invention. It is intended that the appended claims be construed to include alternate implementations to the extent permitted.

1. A method for using personal data assets from a plurality of devices, the method comprising:
receiving information for a user profile for each of a plurality of users, wherein each of the plurality of users is associated with a group, wherein each user profile includes information identifying at least one device of the plurality of devices for each respective user of the group, and wherein each device of the plurality of devices is capable of generating personal data assets;
storing personal data assets received via each of the plurality of devices;
aggregating some of the personal data assets associated with a plurality of users associated with the group;
allowing access to the aggregation of personal data assets by a third party for a fee; and
receiving an indication of payment to an entity associated with the group, the indication of payment communicating that a portion of the fee was successfully paid to the entity associated with the group.

2. The method of claim 1, further comprising:
after receiving information for the user profile for each of the plurality of users, providing a user interface element through which a user of the plurality of users may opt out of the storing of personal data assets associated with a particular device.

3. The method of claim 1, further comprising:
after receiving information for the user profile for each of the plurality of users, providing a user interface element through which a user of the plurality of users may opt-in to the storing of personal data assets associated with a particular device.

4. The method of claim 1, further comprising:
identifying a device associated with one of the users of the plurality of users associated with the group by (1) analyzing data generated from the said device and (2) correlating the generated data with other data generated by devices used by other users of the plurality of users associated with the group; and
sending an invitation to an account associated with the identified device, wherein the invitation provides an option to opt-in to the group.

5. The method of claim 4, wherein the invitation sent to the account associated with the identified device includes an invitation to opt-in to the storing of personal data assets.

6. The method of claim 4, wherein the identified device is a second device associated with one of the users of the plurality of users, wherein a first device associated with the said one of the users of the plurality of users has generated personal data assets, and wherein the generated personal data assets were previously aggregated.

7. The method of claim 4, wherein the method further comprises:
receiving an indication of payment to the said one of the users of the plurality of users associated with the group when personal data assets from the second device (associated with one of the users of the plurality of users) are made available to the third party.

8. One or more physical computer-accessible media encoded with instructions for performing a method, the method comprising:
receiving information for a user profile for each of a plurality of users, wherein each of the plurality of users is associated with a group, wherein each user profile includes information identifying at least one device for each respective user of the group, and wherein each device is capable of generating personal data assets;
storing personal data assets received via the devices;
aggregating some of the personal data assets associated with a plurality of users associated with the group;
allowing access to the aggregation of personal data assets by a third party for a fee; and
receiving an indication of payment for an entity associated with the group, the indication of payment communicating that a portion of the fee was successfully paid to the entity associated with the group.

9. The one or more physical computer-accessible media of claim 8, the method further comprising:
after receiving information for the user profile for each of the plurality of users, providing a user interface element through which a user of the plurality of users may opt out of the storing of personal data assets associated with a particular device.

10. The one or more physical computer-accessible media of claim 8, the method further comprising:
after receiving information for the user profile for each of the plurality of users, providing a user interface element through which a user of the plurality of users may opt-in to the storing of personal data assets associated with a particular device.

11. The one or more physical computer-accessible media of claim 8, the method further comprising:
identifying a device associated with one of the users of the plurality of users associated with the group by (1) analyzing data generated from the said device and (2) correlating the generated data with other data generated by devices used by other users of the plurality of users associated with the group; and
sending an invitation to an account associated with the identified device, wherein the invitation provides an option to opt-in to the group.

12. The one or more physical computer-accessible media of claim 11, wherein the invitation sent to the account associated with the identified device includes an invitation to opt-in to the storing of personal data assets.

13. The one or more physical computer-accessible media of claim 11, wherein the invitation sent to the account associated with the identified device includes an option to allow a user of the plurality of users associated with the group to share personal data assets without the possibility of being remunerated when opting in to sharing of personal data assets from the newly identified device.

14. The one or more physical computer-accessible media of claim 11, wherein the identified device is a second device associated with one of the users of the plurality of users, wherein a first device associated with the said one of the users of the plurality of users has generated personal data assets, and wherein the generated personal data assets were previously aggregated.

15. The one or more physical computer-accessible media of claim 11, wherein the method further comprises:
receiving an indication of payment to the said one of the users of the plurality of users associated with the group when personal data assets from the second device (associated with one of the users of the plurality of users) are made available to the third party.

16. A physical server that provides a service to a plurality of users for collecting personal data assets of users, comprising:
a processor; and
a memory coupled to the processor, the memory storing instructions which when executed by the processor causes the server to perform a method, comprising:
storing data associating a device of a plurality of devices with a respective user of a plurality of users, for each of the plurality of devices;
storing a group identifier for each of the users of the plurality of users and associating the group identifier with each of the users of the plurality of users;
storing data generated by interactions between respective users and devices;
aggregating on demand by a third party stored data generated by the interactions between respective users and devices; and
allowing access to the aggregation of personal data assets by the third party for a fee.

17. The physical server of claim 16 wherein the method further comprises:
storing information about purchases made by users; and
associating the information about the purchases made by users with respective users and with the group identifier.
